(19) United States
(12) Patent Application Publication
(10) Pub. No.: US 2002/0024821 A1
(43) Pub. Date: Feb. 28, 2002

(54) DEVICE ARRANGEMENT OF LED LIGHTING UNITS

(76) Inventor: GEORGE YEN, TAIPEI (TW)

Correspondence Address: DOUGHERTY & TROXELL, 5205 LEESBURG PIKE, SUITE 1404, FALLS CHURCH, VA, 22041-3401, US

(21) Appl. No.: 09/447,834

(22) Filed: Nov. 23, 1999

(51) Int. Cl. F21S 2/00

(52) U.S. Cl. 362/555

(57) ABSTRACT

The present invention discloses a light-emitting diode (LED) light source and, more particularly, the lighting units that homogeneously mix the light beams from LEDs of different shapes to achieve a superior light mixing effect.

### BACKGROUND OF THE INVENTION

1. Field of Invention

The present invention relates to the improvement of a light-emitting diode (LED) light source and, more particularly, to the development of lighting units that homogeneously mix the light beams from LEDs of different shapes to achieve a superior light mixing effect.

2. Related Art

Light-emitting diode (LED) technology has had a great progress. The lighting efficiency and unit luminosity are grown logarithmically. Therefore, using LEDs as lighting units in practice should be within a number of years. However, since each kind of LEDs is made by a different material, the lighting method is also different. This in turn affects the beam shape from the LED. This feature causes no problem in most applications, yet has a great influence on certain situations.

Our company discovers this light source phenomenon when doing research on a special luminaire composed of highly luminous RGB LEDs. So the present invention is accomplished after many times of experiments.

Since the lighting method of LEDs belongs to semiconductor lighting, the light emitted has a unique wavelength. Although there are white LEDs, they are made by having blue light as the primary light and applying a fluorescent to convert the blue light into lights of different wavelengths. Thus the lighting efficiency is not high enough Under the current circumstances that the LED lighting efficiency cannot be promoted, the RGB LEDs as the light sources have the most efficient luminosity. For example, the luminosity of a single white diode is about 2.0 CD (at the angle of 15 degrees), that of a blue diode is about 3 CD, but that of a green diode can reach 8 CD and that of a red diode can have 3.5 CD or so. Taking each of the red, green, and blue LEDs to form a lighting unit would have a total luminosity of about 15 CD. However, taking three white LEDs to form a light unit would have a total luminosity between 6 to 8 CD. Considering the price, the three red, green, and blue LEDs would cost about ⅔ of the price of three white LEDs. Therefore, the luminaire composed of the RGB LEDs for now and the near future definitely would be more practical than using white LEDs. It can also achieve the effect of varying color by controlling the output of each single color LED.

Since the beam shape 11 (as shown in FIG. 2) of the red LED 1 (as shown in FIG. 1) is different from those beam shapes 21, 31 (shown in FIG. 4) of the blue LED 2 and the green LED 3 (shown in FIG. 3), respectively, therefore, when all three colors are projected on an object it will not be perfectly white and has inhomogeneous speckles 101 on the rim of the beam. The reason is that the red LED 1 only need one whisker, thus the central area is dark and the light beam after a resin lens has a circular shape (as shown in FIG. 2). The blue and green LEDs 2, 3 need two whiskers for electric conduction, these two whiskers usually set on the diagonals. Thus the dark areas of the chip rest on the diagonals. After the projection through lenses, the beams become elliptical (as shown in FIG. 4). This shape is not easy to be modified by a correction resin lens because mass production could not assume the precision required. Accordingly, when those two LEDs 2, 3 and the red LED 1 combine to form a luminaire, beams of different colors would have different projection shapes (shown in FIG. 5) and red speckles 101 form at places where blue and green light cannot reach.

There are various methods for solving the above situation. One is to place lenses with different refractivities in front of the LEDs so that the lenses can have different refractive effects on lights from individual LEDs. This method, however, is not practical. Not only does the lens cost too much, the lens also has to be redesigned once the arrangement of the LEDs changes. Another method is to place a dispersion plate in front of the LEDs to fully mix all colors and the light emerging therefrom would be very homogeneous. Yet the application of the luminaire would be limited because the dispersed light can not be focused and has a lower luminosity.

### SUMMARY OF THE INVENTION

It is an object of the present invention to provide a light-emitting diode (LED) light source and, more particularly, a structure of lighting units that homogeneously mix the light beams from LEDs of different shapes to achieve a superior light mixing effect.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a front view of a usual red LED;

FIG. 2 is a schematic view of the projection beam from the red LED of FIG. 1;

FIG. 3 shows front views of usual blue and green LEDs;

FIG. 4 shows schematic views of the projection beams from the blue and green LEDs of FIG. 3;

FIG. 5 is a schematic view of the projection beam from a conventional luminaire composed of blue, green and red LEDs;

FIG. 6 is a schematic view of the projection beam from a luminaire that has two groups of red, green, and blue LEDs rotated from each other by 90 degrees according to the present invention;

FIG. 7 is a schematic view of the projection beam from a luminaire that has three groups of red, green, and blue LEDs rotated from one another by 60 degrees according to the present invention;

FIG. 8 is a schematic view of the arrangement of two groups of red, green, and blue LEDs rotated 90 degrees apart in a luminaire of the present invention;

FIG. 9 is a schematic view of the arrangement of three groups of red, green, and blue LEDs rotated 60 degrees apart in a luminaire of the present invention; and

FIG. 10 is a schematic view of the arrangement of red, green, and blue LEDs on a conventional luminaire board.

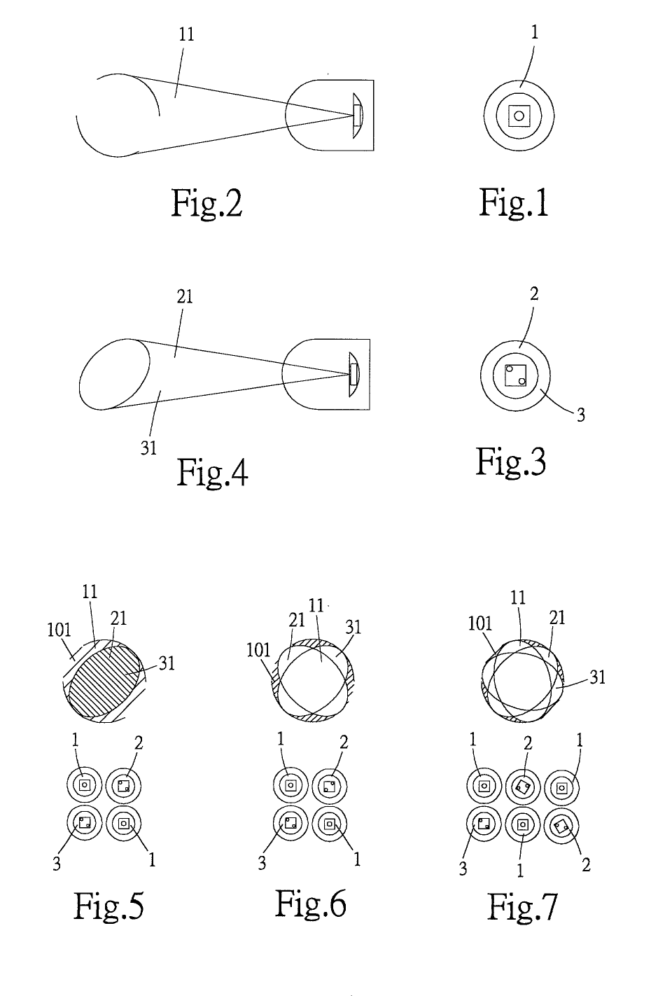

### DETAILED DESCRIPTION OF THE INVENTION

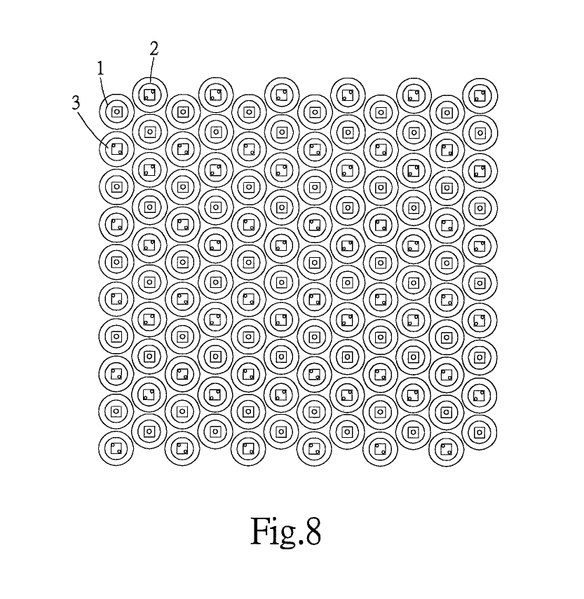

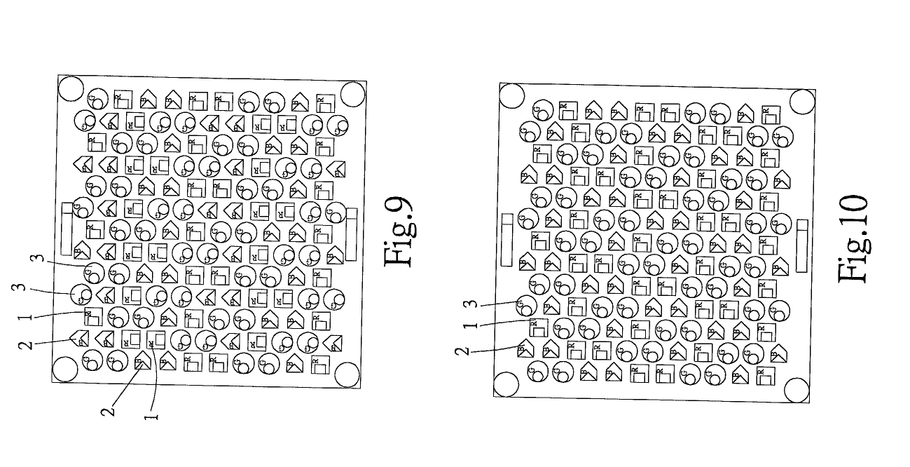

After years of research, the instant invention is obtained. The principle is to dispose all light-emitting elements (a practical LED luminaire has at least tens of units) into a plurality of groups. Each group rotates an angle (as shown in FIG. 6 and 7) so that part of the blue and green elliptical beams 21, 31 are rotated to obtain homogeneously mixed light. Of course the speckles could not be eliminated even if each lighting units is assigned a different angle, yet since each LED has a slightly different lighting character the speckles are not easy to be identified after mixture. In practical testing, rotating only half of the lighting units by 90 degrees (as shown in FIGS. 6 and 8) can achieve a fairly good effect. If all lighting units are separated into three groups with each of them differs from one another by a rotation of 60 degrees, a much better effect can be obtained (as shown in FIGS. 7 and 9).

FIG. 9 depicts the luminaire board designed in experiments of our company. Some of the LEDs are rotated by a certain degrees. FIG. 10 is a conventional design that all LEDs are aligned in the same direction.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device arrangement of light-emitting diode (LED) lighting units, which is a luminaire composed of a plurality of LEDs, part of which are rotated to a certain direction so as to obtain a good light source that eliminates the phenomena of inhomogeneous light mixing and speckles due to different characters of the LEDs.
